(19) United States
(12) Patent Application Publication
(10) Pub. No.: US 2006/0075625 A1
(43) Pub. Date: Apr. 13, 2006

(54) Multiple side processing machine and positioning device for a workpiece

(76) Inventor: Markus Schuster, Fuchstal-Leeder (DE)

Correspondence Address: SCHNECK & SCHNECK, P.O. BOX 2-E, SAN JOSE, CA, 95109-0005, US

(21) Appl. No.: 11/248,637

(22) Filed: Oct. 11, 2005

(30) Foreign Application Priority Data
Oct. 12, 2004 (DE) 10 2004 049 782.6

(51) Int. Cl. B23Q 39/00

(52) U.S. Cl. 29/563

(57) ABSTRACT

The invention relates to a multiple side processing machine for processing several surfaces or sides of a workpiece. The processing machine includes at least two processing units for processing a workpiece and at least a positioning device having a clamping device means for clamping a workpiece. According to the invention, the positioning device is arranged on a displacement device with which a clamped workpiece can be moved between the processing positions of the at least two processing units and wherein the clamping device can be rotated or pivoted around a longitudinal axis (A) and/or a transverse axis (B).

### TECHNICAL FIELD

The invention relates to a multiple side processing machine by means of which a workpiece can be processed on several surfaces or a plurality of sides as well as to a positioning device by means of which a workpiece can be positioned for multiple side processing.

### BACKGROUND ART

From document DE 41 42 121 A1 a transfer line is known for processing a workpiece on several sides or from several sides. Several processing stations are arranged in parallel and the workpieces are further transferred from processing station to processing station on a conveyor device in a predetermined processing cycle. The workpiece is rotated 90° by means of a turning station being arranged between the processing stations in order to enable thus a processing from a different direction in the subsequent processing station. Each processing station features a separate clamping device, with which the workpiece is clamped into this station for being processed. For being turned the workpiece is re-clamped and released also in the turning station. For adjusting the workpiece while clamping, additional elements are provided in each processing station. The repeated clamping of the workpiece can result in orientation inaccuracy between the successively processed surfaces, in particular, if the contacting locations for positioning the workpiece themselves underlie processing-related tolerance variations.

Document DE 100 02 053 C2 describes a pick-up arrangement comprising two workpiece spindles operating according to the pick-up method. Thereby a workpiece spindle can be vertically moved on its slide to receive a workpiece from a workpiece transport system. The slide is supported on two horizontal guidings such that the workpiece spindle can be moved from a loading station to a processing position. On the one side it is thereby not necessary to supply a workpiece of the workpiece spindle by means of a handling, on the other side however the additional degree of freedom of the workpiece spindle (vertical displacement on the slide) results in a heavy spindle construction and thus in a limited moving speed along the horizontal guiding.

In document DE 100 54 856 A1 a workpiece spindle can be moved in horizontal direction between two processing locations. The axis of the workpiece spindle is vertically oriented.

It is thus an object of the invention to provide a multiple side processing machine and a positioning device which enables a processing of the workpiece from several sides under high dimensional accuracy of the processed sides to each other.

### SUMMARY OF THE INVENTION

A multiple side processing machine comprises at least two processing stations or devices for processing a workpiece. The workpiece is clamped into a clamping device of a positioning device and is supported in the clamping device without being re-clamped during the processing in the at least two processing stations. The positioning device is supported on a displacement device, so that the positioning device and thus a clamped workpiece are moveable between the processing positions of the at least two processing stations. A re-clamping of the workpiece between the two processing stations is not necessary, so that from processing position to processing position no maladjustment or a clamping-tolerance-related deviation of the processing can occur.

The clamping device can be rotated or pivoted around its longitudinal axis and/or around a transverse axis perpendicular to the longitudinal axis of the clamping device, so that the workpiece can be re-orientated in one of the processing stations or during the transfer between the processing stations and can be processed from another side by means of the processing station. If, for example, the clamping device can be rotated around its longitudinal axis and if the longitudinal axis is horizontally orientated, a processing of the workpiece in a vertical processing machine can be carried out from all sides by successively rotating the workpiece around the longitudinal axis of the clamping device. If, on the other hand, the clamping device is pivotable around its transverse axis and if also a processing by means of a vertical processing machine is carried out, the workpiece can be processed from two sides and from the end face. The combination of the rotatability and pivotability around the longitudinal and transverse axis of the clamping device results in a five-surfaces-processability, wherein preferably by the ability of positioning in all intermediate positions an all-side-processing of the workpiece is possible, except of this end face of the workpiece, which points towards the clamping device.

In a preferred embodiment, the clamping device itself is arranged on a drive spindle adapted for high rotational speed, so that the workpiece can be rotatingly driven, preferably with up to 1000 r/min. If now in at least one of the processing stations a fixed or non-turning tool is provided, the workpiece can be rotatingly processed with the clamping device being rotating. Preferably, the fixed tool can be displaced in radial and axial direction in respect of the rotational axis of the clamping device. Preferably, the fixed tool is clamped into a stopped tool spindle, so that an exchange of processing can be carried out between the drive of the clamping device and stoppage of the tool spindle to the drive of the tool spindle and stoppage of the clamping device.

Even more preferably, the tools or the tool drives of both processing stations are supported on a common machine base frame, so that on the one hand the required space reduces by using only one common machine base frame and on the other hand the precision increases by more precise orientation of the two processing stations to each other. The processing accuracy can be further increased, when additionally also the displacement device of the positioning device is supported on the machine base frame.

The displacement devices for positioning the processing machine(s), the tools in the processing stations and/or the displacement device of the positioning device are preferably linear drives having linear motors by means of which a reproducible high-precision positioning of the workpiece in the processing positions is ensured.

Preferably, a processing station is a tool spindle for rotationally driving a tool. Such a spindle drive can be a high speed spindle or a rotational drive arranged on a tool turret. In the processing station also a fixed tool can be fed to the workpiece for processing, for example if the clamping device including the clamped workpiece is rotatingly driven.

A processing device in the processing station, in particular a tool spindle, preferably comprises a (tool) fitting for holding exchangeable tools (e.g. lathe chisel, drill, milling cutter, grinding head). Thus several processing cycles can be carried out at the workpiece in a processing station, such as drilling, milling or grinding the workpiece. In particular the exchange of tools is preferably carried out in a fitting by means of a placement device, wherein in this case the tool spindle has not to be horizontally moveable, as the tool to be exchanged is transferred by the placemet device to the axis of the tool spindle. The tool is alternatively provided by a tool supply device in a predetermined loading position of the tool spindle, so that the tool spindle has only to be moved by a short distance between the processing position and the loading position.

If in the processing machine at least two processing stations are provided, which can be tipped with exchangeable tool, the workpiece—after the processing in a first processing station—can be transferred to the second processing station by the positioning device, while in the first processing station a tool exchange is carried out. This correspondingly applies for a tool exchange in the second processing station, so that all in all the processing time is not limited by the tool exchange, as the transfer time between the first and second processing station is very short. For example, in case of metal cutting processing, the auxiliary processing time, i.e. the transfer time between the first and second processing station, is less than 0.3 seconds by using a high speed linear guiding for the positioning device. Especially for processing a workpiece using various different tools the tool exchange is thus not anymore the limiting factor and solely two processing stations are required for a complete processing. As mentioned above, despite the processing by means of different tools, no re-clamping of the workpiece is necessary, so that even with a lot of various different processing steps an extremely high accuracy is maintained.

In a preferred embodiment a handling device is associated to the processing machine, which feeds a workpiece into the clamping device and/or takes the processed workpiece out of it. Thus a fully automated processing of the workpiece in a processing machine can be carried out. The unprocessed workpiece is preferably provided in a magazine and by means of the handling device the processed workpiece is re-fed in the same magazine or a further magazine with processed workpieces.

A tool positioning device according to claim 20 includes at least one workpiece spindle having a clamping device for clamping a workpiece. The rotating of the clamping device on the workpiece spindle enables the rotation of the workpiece to different positions for radial processing from different side directions. In the clamped state the workpiece is preferably rotatable with the workpiece spindle at high rotational speed, so that by using a fixed tool a rotational processing of the workpiece is enabled.

In a preferred embodiment, the positioning device comprises a displacement device on which the workpiece spindle is arranged and moveable between at least two processing stations or between a processing station and a loading position. Here preferably the movement is made between a plurality of processing stations and a loading position for loading a workpiece in the clamping device.

### DESCRIPTION OF THE DRAWINGS

FIG. 1 is a side view of a multiple side processing machine of the present invention.

FIG. 2 is an operational view of a clamping unit employing apparatus of FIG. 1 in different processing positions.

FIG. 3 is a top view of the multiple side processing machine of FIG. 1.

FIG. 4 is an embodiment of the multiple side processing machine of FIG. 1 including further processing devices.

FIG. 5 is a further embodiment of the multiple side processing machine of FIG. 1.

FIG. 6 is an embodiment comprising two clamping units, as in FIG. 2, arranged on a guiding member.

FIG. 7 is an illustration of operating cycles when using the two clamping units of FIG. 6.

FIG. 8 is a further embodiment of a clamping unit as in FIG. 2.

### DESCRIPTION OF THE INVENTION

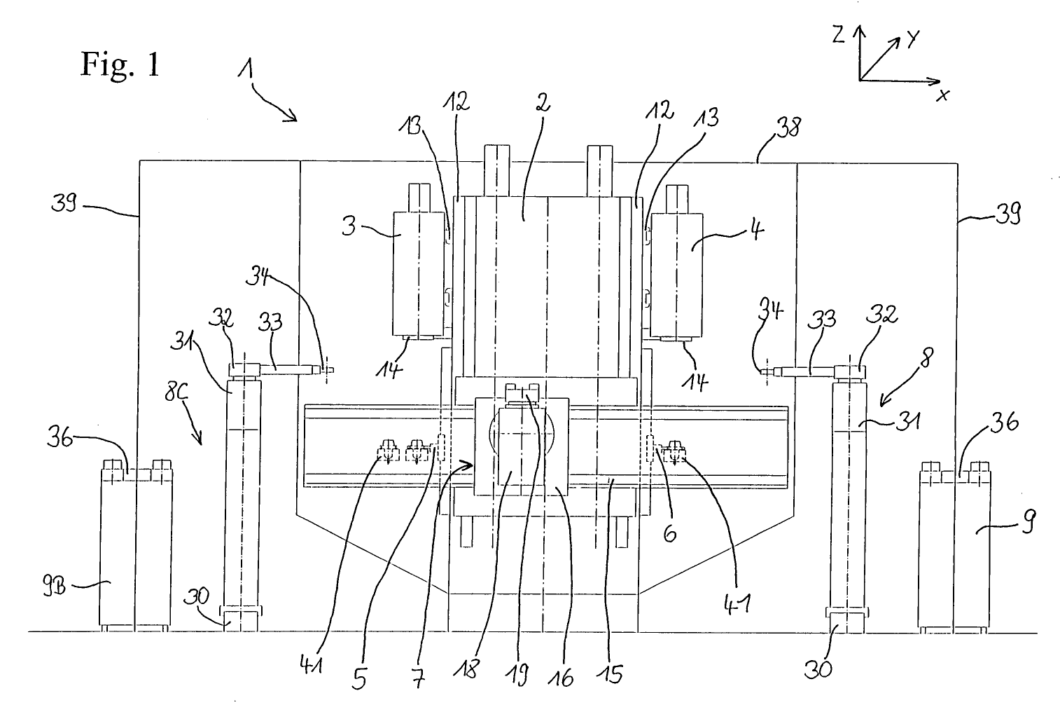

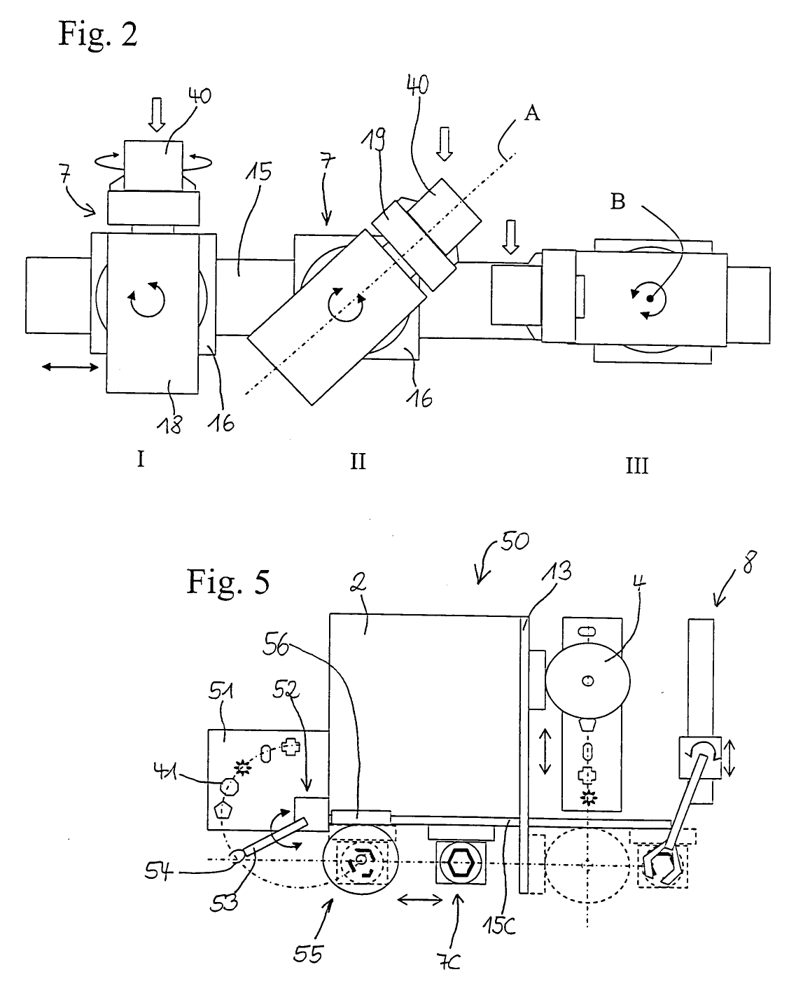

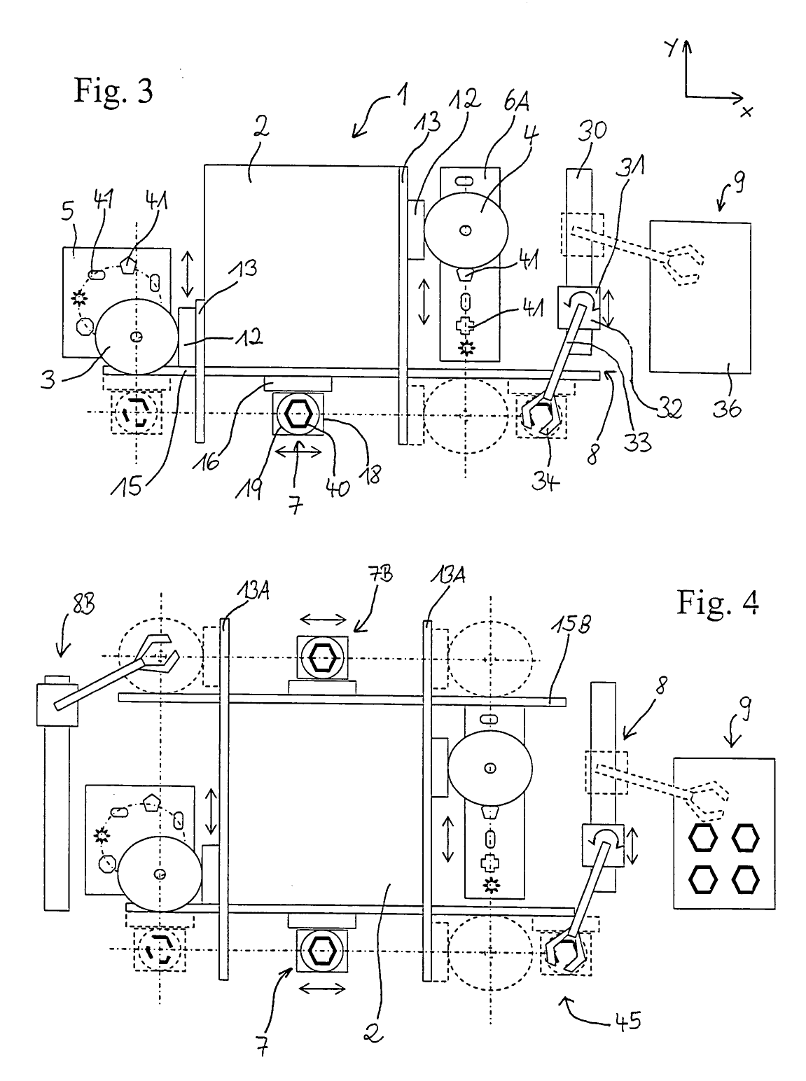

With reference to FIG. 1, a first tool spindle 3 and a second tool spindle 4 of multi-surface processing machine 1 are arranged at the sides of a machine stand 2. Corresponding to the processing conditions various tools 41 (see FIG. 3) are fed to the first tool spindle 3 via a tool exchanger 5. The second tool spindle 4 takes the needed tool out of a tool holder 6. The workpiece 40 to be processed (FIG. 2) is clamped into a clamping unit 7 and is selectively moved to the first or second processing position of the first or second tool spindle 3, 4. The unprocessed workpiece 40 is fed to the clamping unit 7 by means of a first handling 8 and with this the processed workpiece 40 is taken out of the clamping unit 7. The first handling 8 fetches the unprocessed workpieces from a palletizing device 9 in which the processed workpieces are fed back for intermediate storing.

As an option an unprocessed workpiece is fed to the clamping unit 7 by means of a second handling 8C and the processed workpiece is again removed by means of the first handling 8. The second handling 8C fetches the unprocessed workpieces 40 from a second palletizing device 9B including a palletizing table 36.

The first and second tool spindle 3, 4 are each supported on a vertical guiding 12 with which the tool spindle 3, 4 is moveable in vertical direction (in Z-direction as shown by the trihedron of FIG. 1). Horizontal guidings 13 are supported at the vertical guidings 12, so that the tool spindles 3, 4 are moveable along the horizontal guiding 13 for tool exchange (in FIG. 1 perpendicular to the drawing plane). On the bottom side the spindles 3, 4 each comprises a receptacle 14 with which the tool to be currently used is gripped.

The clamping unit 7 is supported on a slide 16 being moveable along a horizontal guiding 15. The horizontal guiding 15 is a linear guiding for high-precision positioning of the slide 16 and thus of the workpiece 40. A spindle drive 18 is rotatably supported on the slide 16 around an axis being perpendicular to the drawing plane of FIG. 1. The spindle drive 18 can be rotated on the slide 16 to a predetermined angular position. The spindle drive 18 drives a clamping head 19 into which the workpiece 40 is clamped.

FIG. 2 schematically shows a side view of the clamping unit 7 in various processing positions. The particular X-positions of the clamping unit 7 along the horizontal guiding 15 are herein only exemplified and do not correspond to the actual position in the respective processing position of the tool spindles 3, 4. In position I of FIG. 2 the workpiece 40 can be processed with one of the tool spindles 3, 4 on the end face and the outer surface, respectively (workpiece rotating). If the spindle 18 is driven, a workpiece can be clamped into the tool spindle 3 or 4 with the spindle shaft of the tool spindle 3, 4 being stopped and thus a rotating processing of the workpiece 40 can be carried out. The rotation by the spindle drive 18 is carried out around its longitudinal axis A, while a rotation of the spindle drive 18 on the slide 16 is carried out around a transverse axis B. In position II the longitudinal axis takes an intermediate position between a vertical orientation (I) and a horizontal orientation (III), so that a surface in the intermediate position between the front and lateral surface can be processed with the spindle of the spindle drive 18 being fixed. In position III the workpiece can be processed sideways by means of a tool spindle 3, 4, wherein the rotational position of the spindle of the spindle drive 18 can be predefined in any desired position between 0 and 360° for processing the workpiece 40.

The handlings 8, 8C are arranged on a linear bottom guiding 30 (see also FIG. 3 in which however only the first handling 8C is shown), with which the handlings are moveable in Y-direction (perpendicular to the drawing plane in FIG. 1). Each handling 8, 8C comprises a column-like vertical displacement unit 31 with which a gripping arm 33 pivotably supported at a pivoting bearing 32 can be moved upwards and downwards. The gripping arm 33 can be horizontally pivoted at the pivoting bearing 32 and comprises on its front end a gripper 34 for gripping a workpiece 40. By means of the handling 8, 8C the workpiece is moved between the clamping unit 7 and the palletizing device 9, wherein the workpiece 40 is removed from a pallet table 36 of the palletizing device 9 for being processed and/or is deposited on the pallet table 36 after being processed.

As indicated in FIG. 1 the multiple side processing machine is arranged in a processing cabin 38 and is connected to two handling cabins 39 over two shutter openings not shown through which the gripping arm 33 of the corresponding handling 8, 8C is gripping. The pallet table 36 of the respective palletizing device 9, 9B for intermediate storage of the workpieces has respectively a part lying within and outside the handling cabin 39, wherein the outer part is for the automatic or manual placement of the pallet table 36 with workpieces.

FIG. 3 shows a schematic top view of the multiple side processing machine of FIG. 1 in which by means of dash-dotted lines the displacement paths of the spindle axes of the first and second tool spindle 3, 4 and the clamping unit 7 are shown. In FIG. 3 the first tool spindle 3 is positioned in its tool exchanging position in which by means of the tool exchanger 5 the tool to be used in the subsequent processing step can be positioned below the fitting or receptacle 14 of the tool spindle 3. By vertically lowering the tool spindle 3 the tool 41 supplied in the carrousel of the tool exchanger 5 is gripped. Beforehand, the tool not needed anymore has been deposited in an empty position of the tool carrousel by lowering the tool spindle 3 in the tool exchanging position onto the tool carrousel. The second tool spindle 4 is displaced backwards in Y-direction and is positioned for unloading the tool 41 not needed anymore over the provided empty position of the tool holder 6, where the tool is deposited by vertically lowering the second tool spindle 4 and after vertically lifting, horizontally displacing (Y-direction) and again vertically lowering, the next needed tool 41 is gripped.

The processing position of the second tool spindle 4 is on the cross-point of the dash-dotted lines as it is shown by means of the dash line in FIG. 3. The processing position of the first tool spindle 3 is also in the cross-point of the dash-dotted lines for the middle line of the first tool spindle 3 and the spindle of the clamping unit 7. (The displacement path of the first tool spindle 3 in Y-direction and the displacement path of the clamping unit 7 in X-direction are crossing in top view). On the left side of the horizontal guiding 15 the clamping unit 7 is shown in the dashed position in the processing position for the first tool spindle 3. On the right side of the horizontal guiding 15 the clamping unit 7 is shown by dashed line in the workpiece transfer position for the handling 8. By means of continuous lines the clamping unit 7 in FIG. 3 is shown in an intermediate position during the transfer between the two processing positions of the first and second tool spindle 3 and 4.

The transfer time of the workpiece between the processing positions is usually below 0.3 seconds, while the tool exchange usually takes about 2 seconds. Thus a required tool exchange is preferably bridged by transferring the workpiece between the two tool spindles 3, 4, which is carried out significantly faster than a tool exchange at a tool spindle with the clamping unit 7 waiting in a processing position for the subsequent processing step. For the following tool exchange the first tool spindle 3 has then for example an exchange time for its disposal which is composed of the two transfer times between the two processing positions and the processing time at the second tool spindle 4. By means of the handling 8, 8C the exchange of a workpiece in the clamping unit 7 is carried out in only 2 to 3 second, so that all in all a very high workpiece throughput is achieved.

In an embodiment not shown the gripping arm 33 comprises a double gripper, wherein for loading a first gripper takes the processed workpiece out of the clamping unit 7 and a second gripper being already loaded with an unprocessed workpiece loads the unprocessed workpiece into the clamping unit 7. The gripper change in a double gripper is thereby preferably carried out by pivoting around the gripping arm axis.

A partially processed workpiece can also be reversed by a gripping arm 33 being pivotable around the longitudinal gripper axis of the handlings 8 and/or 8C and be re-fed to the clamping unit 7. Thus also the previously inaccessible end face (6^{th} side in the case of a cube) can be processed.

FIG. 4 shows in schematic top view a multiple side processing machine 45 being upgraded as compared to the multiple processing machine 1 in that an additional clamping unit 7B is arranged on the opposite side of the clamping unit 7. The clamping unit 7B is moveable on a horizontal guiding 15B between two additional processing positions of the first and second tool spindle 3, 4. The first and second tool spindles 3, 4 are arranged at elongated horizontal guidings 13A resulting in the additional processing positions along the displacement path of the workpiece being clamped into the clamping unit 7B. Opposite to the handling 8 a further handling 8B is arranged on the other side of the machine stand 2 with which for example a workpiece exchange is carried out at the clamping unit 7B or 7. A workpiece transfer can also be carried out from the clamping unit 7 to the clamping unit 7B to further process the workpiece on the second rail (clamping unit 7B), while on the first rail (clamping unit 7) an unprocessed workpiece is fed by the handling 8. The completely processed workpiece is removed from the second rail (clamping unit 7B) by the handling 8 and intermediately stored on the pallet 36.

Besides a series-connected processing between the first rail and the second rail also a parallel processing on both rails (clamping unit 7 and 7B) can be carried out, wherein a tool exchange at the first or second tool spindle 3, 4 is carried out only, when the processing of the workpieces processed in parallel is carried out with the same tool in the tool spindles. This means that the parallel processing in both rails is carried out with a time offset of one processing step.

FIG. 5 shows a schematic top view onto a multiple side processing machine 50 as a modification of the multiple side processing machine 1 of FIG. 1. Instead of the tool exchanger 5 a tool holder 51 is provided on which the tools 41 are arranged along an arch. By means of a tool handling 52 the tools 41 are taken from the tool holder 51 and returned to an empty position in the tool holder 51, respectively. The tool handling 52 comprises a pivoting arm 53 being vertically displaceable in height and horizontally pivotable. With the pivoting arm 53 a gripper 54 is moveable between one of the tools 41 in the tool holder 51 and a fitting (corresponding no. 14 in FIG. 1) of a tool spindle 55. For the tool exchange a tool is removed with the gripper from the fitting of the tool spindle 55, the tool is deposited in the tool holder 51 and the tool 41 for the subsequent processing step is inserted into the fitting. In an embodiment not shown a tool handling 52 with a double gripper 54 is used with which first a tool is removed from the fitting and the tool for the subsequent processing step is positioned below the fitting by rotating around the pivoting arm axis 53. The tool spindle 55 is arranged on a vertical guiding 56 with which a vertical displacement (Z-direction) of the tool spindle 55 is enabled. A processing in longitudinal direction of the axis of the workpiece is carried out by moving a clamping unit 7C in X-direction during the processing by the tool spindle 55. The operation of the tool spindle 4 is carried out as already described above in connection with FIGS. 1 and 2.

As shown in the embodiments above the tool exchange is carried out at the tool spindles with a tool exchanger (for example 5, or 51, 52). Receiving the tool from the exchanger and releasing it to the tool exchanger, respectively, can be carried out in one or two transfer positions in which the tool spindles are positioned. The tools are positioned in a carrousel or in a rotating conveyor belt for receiving/releasing, wherein 40 to 60 tools can be supplied. Or a loading device 52 feeds the tool, wherein also herein the tools are fed to the loading device over a tool exchanger in form of a carrousel or a conveyor belt.

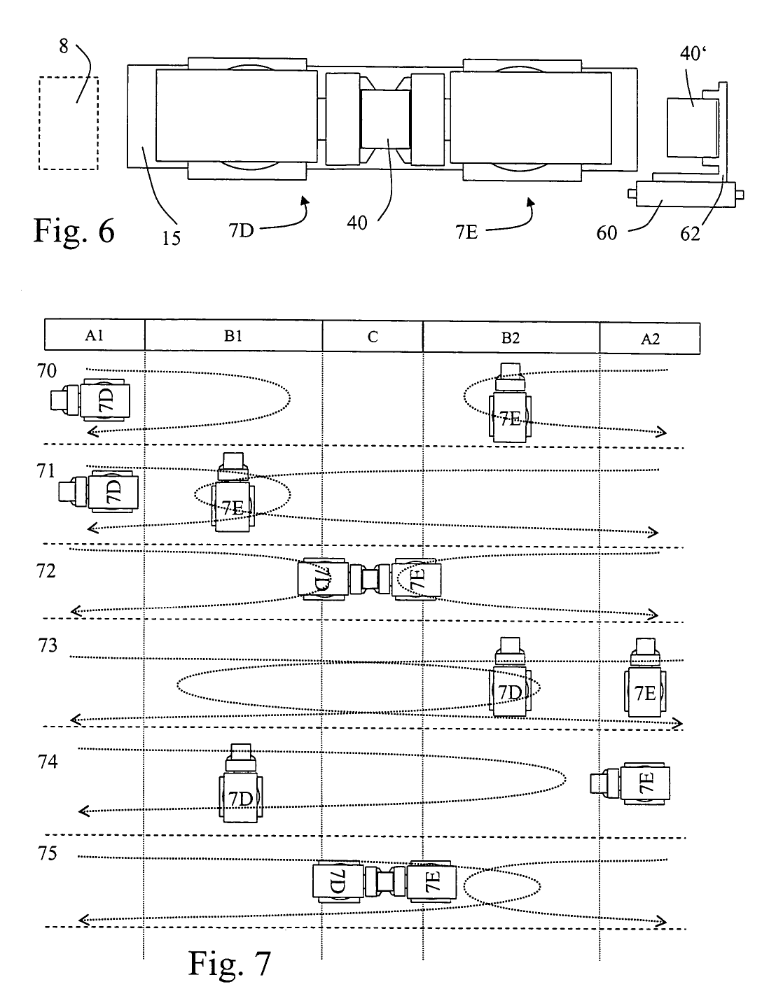

FIG. 6 shows an embodiment of the multiple side processing machines 1, 45 and 50 of FIGS. 1, 4 and 5 in which two clamping units 7D and 7E are arranged on a horizontal guiding 15. The function of the clamping units corresponds to that of the clamping units 7, 7B and 7C. In addition to an independent processing of the workpieces 40 in the clamping units a transfer of a workpiece 40 from the one clamping unit 7D to the other clamping unit 7E or vice versa can be provided herein. FIG. 6 shows the orientation of the clamping units 7D, 7E when transferring the workpiece, wherein the workpiece being clamped in a clamping head 19 of a clamping unit is moved into the opened clamping head (clamping jaws are opened) of the other clamping unit and is then gripped by it by closing the clamping jaws. After this, the first clamping head 19 releases the clamping jaws and unclamps thus the workpiece for the other clamping unit. The transfer can be carried out along the displacement path of the horizontal guiding at an arbitrary location, preferably at a location resulting in a minimal transfer time.

The removal and/or the supply of the workpiece 40 to/from the left clamping unit 7D is carried out by means of the handling 8 shown by dotted line. The removal and/or supply of a workpiece 40′ to/from the right clamping unit 7E is carried out by means of an active or a passive clamping socket 62. The clamping unit 7E perpendicularly inserts a workpiece 40′ being clamped in the clamping unit 7E into the clamping socket (in X-direction rightwards in FIG. 6), where the workpiece 40′ can be either passively clamped by the insertion or actively clamped by an actuator of the clamping socket 62. The removal of a workpiece from the clamping socket is carried out inversely. A plurality of clamping sockets 62 is arranged on a conveyor device 60. The conveyor device 60 supplies a workpiece 40′ to be processed for the clamping unit 7E and/or moves a processed workpiece 40′ away from the clamping unit 7E. Also the above described arrangements of handlings 8, 8B or 8C can be used.

It is obvious that such a unit consisting of two clamping units 7D, 7E and a horizontal guiding can be used as such in each type of tool machine or processing machine and is not only limited for being used in the machines 1, 45 and 50 of the above embodiments.

FIG. 7 exemplifies processing cycles for the arrangement according to FIG. 6. Column Al shows the receiving/releasing of the workpiece from the clamping unit 7D to the handling and vice versa. Column B1 symbolizes the processing position of the workpiece for being processed by the first processing device (e.g. with the tool spindle 3 or 55). Column C symbolizes the workpiece transfer, wherein the spatial X-position can be located at each accessible location of the guiding 15 as mentioned above. Column B2 symbolizes the processing position of the workpiece for being processed by the second processing device (e.g. with the tool spindle 4). Column A2 shows the receiving/releasing of the workpiece from the clamping unit 7E to the clamping socket 62 or vice versa.

In mode 70 (shown by the row indicated by 70) both clamping units 7D, 7E operate independent of each other: 7D only in the left processing position B1 and 7E only in the right processing position B2. No change between the processing positions B1 and B2 and no workpiece transfer C is carried out.

In mode 71 the clamping unit 7D only moves to the left processing position B1 and the clamping unit 7E moves to both processing positions B1 and B2. No workpiece transfer C is carried out.

In mode 72 the clamping unit 7D only moves to the left processing position B1 and the clamping unit 7E only moves to the right processing position B2. A workpiece transfer C is carried out between the clamping units 7D and 7E or vice versa. A transfer C can also be carried out first in the one and then in the other direction.

In mode 73 the clamping unit 7D moves to both processing positions B1 and B2 and the clamping unit 7E also moves to both processing positions B1 and B2. No workpiece transfer C is carried out.

In mode 74 the clamping unit 7D moves to both processing positions B1 and B2 and the clamping unit 7E solely carries out a workpiece transfer C, i.e. in this case the clamping unit 7E operates itself as a handling.

Preferably the clamping unit moves for transfer to a location where the moving times of the clamping unit 7D are minimized.

In mode 75 the clamping unit 7D moves to both processing positions B1 and B2 and the clamping unit 7E only moves to the processing position B2. A workpiece transfer C is carried out between the clamping units.

A plurality of further modes is possible. For example it can be further provided that the workpiece transfer C is carried out while both clamping units 7D, 7E are moving along the guiding 15. All in all the arrangement of FIG. 6 thus enables a great potential for the optimization of time and processing cycles. Thus the different types of workpieces can be processed in a complex and very fast manner.

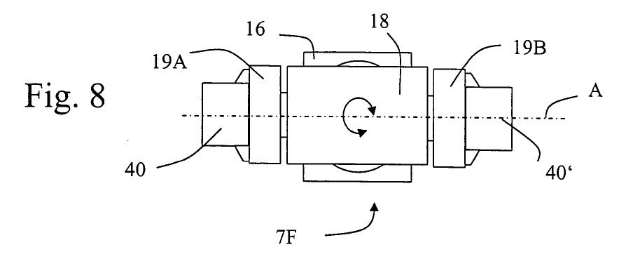

FIG. 8 shows a double clamping unit 7F as an embodiment of one of the above described clamping units 7, 7B to 7E. A clamping head 19A, 19B being synchronously driven by the drive 18 is arranged at each of both ends of the spindle drive 18 in the clamping unit 7F. The clamping/releasing of the workpieces 40, 40′ in the clamping heads 19A, 19B is preferably carried out independent of each other, so that the supply and the removal of the workpieces 40, 40′ can be successively carried out, e.g. by the handlings 8, 8B or 8C or the clamping socket 62. As the other clamping units, the double clamping unit 7F is rotatably supported on the slide 16 being moveable along the horizontal guiding 15, 15A. In the arrangement of FIG. 6 for example one or two double clamping units 7F can be provided.

What is claimed is:

1. Multiple side processing machine for processing several surfaces or sides of a workpiece, the processing machine comprising:
at least two processing units for processing a workpiece; and
at least a positioning device having at least one clamping device for clamping a workpiece, the positioning device being arranged on a displacement device with which a clamped workpiece can be moved between the processing positions of the at least two processing units and wherein the clamping device can be rotated or pivoted around a longitudinal axis (A) and/or a transverse axis (B).

2. The multiple side processing machine according to claim 1, wherein the at least one clamping device can be positioned under an arbitrary or at least two predefined rotation angles.

3. The multiple side processing machine according to claim 1, wherein the at least one clamping device is arranged on a drive spindle.

4. The multiple side processing machine according to claim 3, wherein the at least one clamping device can be driven by a rotational speed of at least 100 r/min.

5. The multiple side processing machine according to claim 1, wherein a workpiece can be rotatingly processed by means of a tool fixedly clamped in one of the processing units while the clamping device is rotating.

6. The multiple side processing machine according to claim 1, wherein the longitudinal axis (A) of the clamping device is horizontally orientated.

7. The multiple side processing machine according to claim 1, wherein the clamping device is located in predefined rotational positions by means of hydraulic clamping.

8. The multiple side processing machine according to claim 1, wherein the at least two processing units are supported on a common machine base frame.

9. The multiple side processing machine according to claim 1, wherein at least one of the processing units is arranged on a displacement device with which the processing unit can be vertically moved.

10. The multiple side processing machine according to claim 1, wherein at least one of the processing units is arranged on a displacement device with which the processing device can be horizontally moved between a processing position and at least one tool loading position.

11. The multiple side processing machine according to claim 1, wherein at least one of the processing units comprises a receptacle for an exchangeable tool.

12. The multiple side processing machine according to claim 11 further comprising a loading device means for loading and unloading tools in at least one of the processing devices.

13. The multiple side processing machine according to claim 11 further comprising at least one tool supply device providing a tool to be used to a loading position of at least one of the processing units.

14. The multiple side processing machine according to claim 10, wherein the displacement device of the at least one positioning device is supported at a machine base frame.

15. The multiple side processing machine according to claim 10, wherein the displacement device of at least one of the processing devices comprises a horizontally or vertically running linear guiding member.

16. The multiple side processing machine according to claim 1 further comprising
at least one handling device means for feeding a workpiece to the clamping device and taking a workpiece out of the clamping device of the at least one positioning device and
at least one supply device means for transferring a workpiece from or to the clamping device of the positioning device.

17. The multiple side processing machine according to claim 1, wherein at least one of the processing units is a tool spindle or a tool turret.

18. The multiple side processing machine according to claim 1, wherein two or more positioning devices are each arranged on a slide and can be moved independent of each other on a guiding member.

19. The multiple side processing machine according to claim 18, wherein the at least two or more positioning devices can be positioned relative to each other with motion means for transferring a workpiece between two positioning devices.

20. A workpiece positioning device for use with a processing machine as set forth in claim 1 comprising at least one workpiece spindle having at least one clamping device means for clamping a workpiece, wherein the at least one clamping device means can be rotated around a longitudinal axis (A) of the workpiece spindle and can be positioned at predefined rotation angles.

21. The positioning device according to claim 20 wherein the workpiece spindle is arranged at a displacement device at a position wherein a clamped workpiece can be moved between at least two processing units or between at least one processing unit and one loading position.

22. The positioning device according to claim 21, wherein at least one of the processing units comprises a tool spindle and a tool turret.

23. The positioning device according to claim 22, wherein at least two positioning devices are each arranged on one slide and are moveable on a guiding member independent of each other.

24. The positioning device according to claim 20, wherein at least two clamping device means are arranged at a positioning device.

25. The positioning device according to claim 24, wherein the at least two clamping device means are adapted to support a workpiece so that the workpiece can be independently clamped and released and the two clamping device means are adapted to be synchronously driven.

26. The positioning device according to claim 20 positioned relative to another such positioning device such that a workpiece can be transferred between the two positioning devices.
